(19) United States
(12) Patent Application Publication
(10) Pub. No.: US 2020/0327045 A1
(43) Pub. Date: Oct. 15, 2020

(54) Test System and Test Method

(71) Applicant: Huawei Technologies Co., Ltd., Shenzhen (CN)

(72) Inventors: Zhe Wang, Xi'an (CN); Ning Li, Xi'an (CN); Dangfei Zhao, Xi'an (CN)

(21) Appl. No.: 16/911,722

(22) Filed: Jun. 25, 2020

Related U.S. Application Data
(63) Continuation of application No. PCT/CN2018/104317, filed on Sep. 6, 2018.

(30) Foreign Application Priority Data
Dec. 28, 2017 (CN) 201711464339.7

(51) Int. Cl. G06F 11/36

(52) U.S. Cl. CPC G06F 11/3684; G06F 11/3696; G06F 11/3692; G06F 11/3688

(57) ABSTRACT

This application includes a case generation unit and a case execution unit. The case generation unit obtains an access request received by to-be-tested software, determines a value range of a request parameter in the access request based on the access request, and generates test cases for the access request based on the value range. Subsequently, the case execution unit executes the test cases for the to-be-tested software.

### CROSS-REFERENCE TO RELATED APPLICATIONS

This application is a continuation of International Patent Application No. PCT/CN2018/104317, filed on Sep. 6, 2018, which claims priority to Chinese Patent Application No. 201711464339.7, filed on Dec. 28, 2017. The disclosures of the aforementioned applications are hereby incorporated by reference in their entireties.

### TECHNICAL FIELD

This application relates to the field of computer technologies, and in particular, to a test system and a test method.

### BACKGROUND

Various types of software, such as a database, a storage service, a virtual machine service, or a container service, run in a network environment. During the running of the software, various problems may occur on an existing network. How to locate software problems on the existing network in a timely manner is a problem that urgently needs to be resolved by software operations and maintenance (O&M) personnel. A current test tool obtains, using an agent that is set in software, requests received by the running software, and periodically replays these requests, to test the software. This method can reproduce only a historical scenario. This limits a test scenario and cannot ensure test accuracy.

In addition, if a software developer designs a test case, additional workload is caused. Moreover, the manually designed test case has a limitation and cannot ensure test accuracy.

### SUMMARY

This application provides a test method, to improve test accuracy.

A first aspect of this application provides a test method, including obtaining, by a test system, an access request received by to-be-tested software, where the access request includes an operation code, a Uniform Resource Locator (URL), and a request parameter, obtaining, by the test system, a value range of the request parameter in the access request, generating, by the test system based on the value range of the request parameter in the access request, a plurality of test cases corresponding to the access request, where each test case includes the operation code and the URL, and a request parameter included in the test case is within the value range of the request parameter in the access request, and executing, by the test system for the to-be-tested software, the plurality of test cases corresponding to the access request.

In a possible design, the access request further includes a request body, and the method includes obtaining, by the test system, a value range of the request body in the access request. The generating, by the test system based on the value range of the request parameter in the access request, a plurality of test cases corresponding to the access request includes generating, by the test system based on the value range of the request parameter in the access request and the value range of the request body in the access request, the plurality of test cases corresponding to the access request. The request parameter included in the test case is within the value range of the request parameter in the access request, and a request body included in the test case is within the value range of the request body in the access request.

In a possible design, the obtaining, by the test system, a value range of the request parameter in the access request includes obtaining, by the test system, a plurality of preceding access requests, where each preceding access request includes the operation code and the URL, and determining, by the test system, the value range of the request parameter in the access request based on request parameters in the plurality of preceding access requests.

In a possible design, the method includes determining, by the test system, a preceding access request on which the access request depends, and before executing, for the to-be-tested software, the plurality of test cases corresponding to the access request, sending, by the test system, the depended-on preceding access request to the to-be-tested software.

In a possible design, the method includes obtaining, by the test system, a frequency of invoking the access request that carries the URL, and determining, by the test system based on the frequency, a frequency of executing, for the to-be-tested software, the plurality of test cases corresponding to the access request.

A second aspect of this application provides a test system. The test system is configured to perform the test method according to the first aspect, and the possible designs of the method. The test system includes at least one physical server. Each physical server includes at least one processor and a memory. Each processor is connected to the memory. The processor is configured to obtain an access request received by to-be-tested software, where the access request includes an operation code, a URL, and a request parameter, obtain a value range of the request parameter in the access request, generate, based on the value range of the request parameter in the access request, a plurality of test cases corresponding to the access request, where each test case includes the operation code and the URL, and a request parameter included in the test case is within the value range of the request parameter in the access request, and execute, for the to-be-tested software, the plurality of test cases corresponding to the access request.

In a possible design, the processor is configured to obtain a value range of a request body in the access request, and generate, based on the value range of the request parameter in the access request and the value range of the request body in the access request, the plurality of test cases corresponding to the access request. The request parameter included in the test case is within the value range of the request parameter in the access request, and a request body included in the test case is within the value range of the request body in the access request.

In a possible design, the processor is configured to obtain a plurality of preceding access requests, where each preceding access request includes the operation code and the URL, and determine the value range of the request parameter in the access request based on request parameters in the plurality of preceding access requests.

In a possible design, the processor is configured to determine a preceding access request on which the access request depends, and before executing, for the to-be-tested software, the plurality of test cases corresponding to the access request, send the depended-on preceding access request to the to-be-tested software.

In a possible design, the processor is configured to obtain a frequency of invoking the access request that carries the URL, and determine, based on the frequency, a frequency of executing, for the to-be-tested software, the plurality of test cases corresponding to the access request.

A third aspect of this application provides a non-volatile storage medium configured to store program code. When the program code is run by a physical server, the physical server performs the test method according to the first aspect, and the possible designs of the method. Specifically, the physical server is configured to obtain an access request received by to-be-tested software, where the access request includes an operation code, a URL, and a request parameter, obtain a value range of the request parameter in the access request, generate, based on the value range of the request parameter in the access request, a plurality of test cases corresponding to the access request, where each test case includes the operation code and the URL, and a request parameter included in the test case is within the value range of the request parameter in the access request, and execute, for the to-be-tested software, the plurality of test cases corresponding to the access request.

The storage medium includes but is not limited to a flash memory, a hard disk drive (HDD), or a solid-state drive (SSD).

In a possible design, the physical server is configured to obtain a value range of a request body in the access request, and generate, based on the value range of the request parameter in the access request and the value range of the request body in the access request, the plurality of test cases corresponding to the access request. The request parameter included in the test case is within the value range of the request parameter in the access request, and a request body included in the test case is within the value range of the request body in the access request.

In a possible design, the physical server is configured to obtain a plurality of preceding access requests, where each preceding access request includes the operation code and the URL, and determine the value range of the request parameter in the access request based on request parameters in the plurality of preceding access requests.

In a possible design, the physical server is configured to determine a preceding access request on which the access request depends, and before executing, for the to-be-tested software, the plurality of test cases corresponding to the access request, send the depended-on preceding access request to the to-be-tested software.

In a possible design, the physical server is configured to obtain a frequency of invoking the access request that carries the URL, and determine, based on the frequency, a frequency of executing, for the to-be-tested software, the plurality of test cases corresponding to the access request.

### BRIEF DESCRIPTION OF DRAWINGS

FIG. 1 is a schematic diagram of a software application system according to an embodiment of this application.

FIG. 2 is a schematic diagram of a software application system according to an embodiment of this application.

FIG. 3 is a schematic flowchart of a test method according to an embodiment of this application.

FIG. 4 is a schematic structural diagram of a physical server according to an embodiment of this application.

### DESCRIPTION OF EMBODIMENTS

The following describes the technical solutions in the embodiments of this application with reference to the accompanying drawings in the embodiments of this application.

In this application, terms such as “first” and “second” are used to distinguish between objects, but “first” and “second” have no dependency on each other in logic or order.

Throughout this specification, a test case includes a set of conditions or variables. A tester can determine, based on a test result of the test case for to-be-tested software, whether the to-be-tested software satisfies a requirement or runs properly.

Throughout this specification, a client may be a device such as a virtual machine, a physical machine, or a tablet. A user can access to-be-tested software in a service system using the client.

Software Application System to which the Embodiments of this Application are Applied

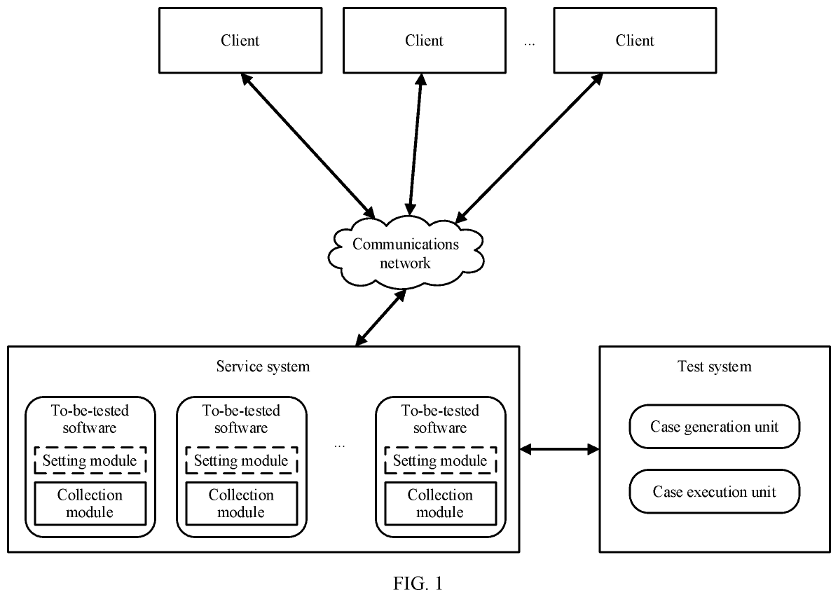

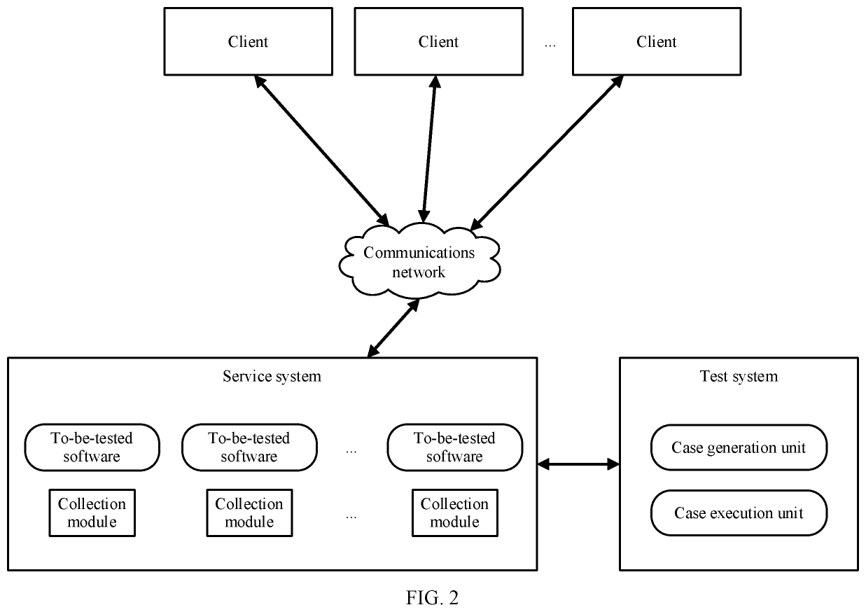

As shown in FIG. 1 or FIG. 2, the software application system includes a plurality of clients, a service system, and a test system. The clients access the service system over a communications network. A common service system may be a public cloud. A communication connection is established between the service system and the test system. The service system includes a plurality of physical servers. The test system includes a plurality of physical servers.

A plurality of pieces of to-be-tested software run in the service system, and one or more pieces of to-be-tested software run on each physical server. The test system includes a case generation unit and a case execution unit. Each unit may include one or more physical servers.

As shown in FIG. 1, a collection module may be deployed in the to-be-tested software. Such deployment is referred to as intrusive deployment. The collection module is configured to collect an access request received by the to-be-tested software and an access response sent by the to-be-tested software, and send the access request and the access response to the test system. The collection module may obtain the access request and the access response by monitoring a network adapter of a physical server on which the to-be-tested software is located, monitoring an operating system of the physical server on which the to-be-tested software is located, or the like, and send the access request and the access response to the case generation unit.

In this deployment scenario, a setting module may be further deployed in the to-be-tested software. A designer of the to-be-tested software may set, in the setting module, a value range of a request parameter and/or a request body in an access request and a dependency relationship between access requests.

As shown in FIG. 2, the collection module may alternatively be deployed outside the to-be-tested software, that is, deployed on the physical server on which the to-be-tested software is located. Such deployment is referred to as non-intrusive deployment. In this deployment scenario, because the collection module is deployed outside the to-be-tested software, the designer of the to-be-tested software cannot preset a value range of a request parameter and/or a request body in an access request and a dependency relationship between access requests.

In an example scenario, a user sends an access request, for example, a request for virtual machine establishment, to to-be-tested software such as a virtual machine management platform using a client. The to-be-tested software establishes a virtual machine based on the access request, and adds related information of the established virtual machine to an access response and sends the access response to the client such that the client can subsequently access the established virtual machine using the related information. The to-be-tested software may be updated during running. The to-be-tested software may have a defect in a design phase, or various exceptions may occur on a physical server on which the to-be-tested software is located, such as an insufficient memory capacity and an operating system fault. The to-be-tested software cannot process an access request or correctly process some access requests due to the update, defect, or exceptions. Therefore, the to-be-tested software needs to be periodically tested, to ensure that a function and running status of the to-be-tested software are normal.

In view of this, this application provides a test system and a test method based on the test system. The test system receives an access request obtained by to-be-tested software, automatically generates test cases, and executes the test cases for the to-be-tested software. This improves test accuracy and coverage.

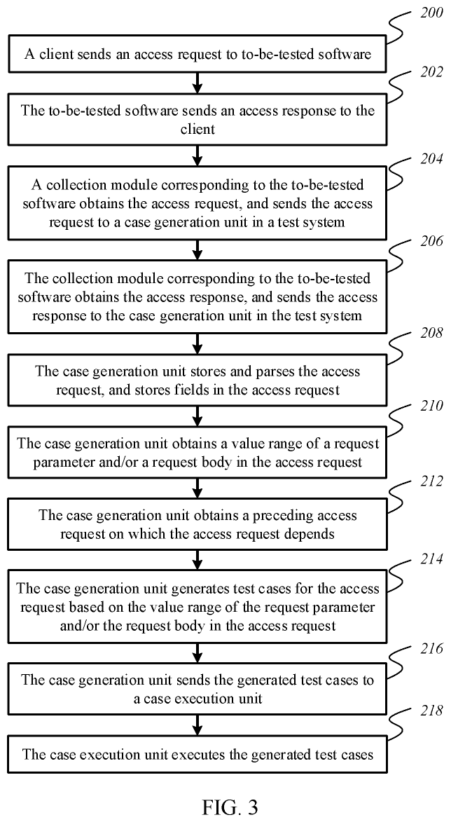

FIG. 3 describes a test method based on the system shown in FIG. 1 or FIG. 2.

200. A client sends an access request to to-be-tested software.

The access request may be a Hypertext Transfer Protocol (HTTP) request, for example, GET http://192.168.1.1:8080/servers?name=test. The access request includes the following fields, and content of the fields is an example request header: header 1;

operation code: GET;

uniform resource locator (URL): http://192.168.1.1:8080/servers;

request parameter: name-test;

request body: null.

The GET request is an access request, and therefore may not carry a request body. Another type of request, such as a POST request for modification, may carry a request body.

202. The to-be-tested software sends an access response to the client.

The access response may be an HTTP response. The access response includes the following fields, and content of the fields is an example

return code: 200;
response body:
{“name”: “test”,
“flavor”: “large”,
“status”: “running”
}.

There are various types of return codes. It can be determined, based on the return code, whether the access request is normally responded. For example, 200, 201, 202, or the like indicates a normal response, 400 indicates a bad request, 404 indicates not found, and 500 indicates an internal error. For details, refer to HTTP status codes. When the access response from the to-be-tested software is abnormal, the access response may not carry the response body.

204. A collection module corresponding to the to-be-tested software obtains the access request, and sends the access request to a case generation unit in a test system.

206. The collection module corresponding to the to-be-tested software obtains the access response, and sends the access response to the case generation unit in the test system.

An execution sequence of steps 204 and 206 is not limited, or steps 204 and 206 may be concurrently performed. Step 204 may be performed at any moment after step 200. Step 206 is optional. In other words, in a phase of generating test cases, the collection module may not send the access response to the case generation unit in the test system.

208. The case generation unit stores and parses the access request, and distinguishes and stores the fields in the access request.

If step 206 is performed, the case generation unit further distinguishes and stores the fields in the access response in step 208, for example

operation code: GET;
request header: header 1;
URL: http://192.168.1.1:8080/servers;
request parameter: name=test;
request body:
{body: ...
};
return code: 200;
response body:
{“name”: “test”,
“flavor”: “large”,
“status”: “running”
}.

210. The case generation unit obtains a value range of the request parameter and/or the request body in the access request.

For intrusive deployment and non-intrusive deployment, there are two implementations of step 210.

In an intrusive deployment scenario, because the value range of the request parameter and/or the request body in the access request is set in a setting module, the case generation unit directly obtains the value range, preset in the setting module, of the request parameter and/or the request body in the access request.

For example, a setting instruction (URL, request parameter, value range) is set and stored in the setting module, to indicate the value range of the request parameter for the URL. The access request received in step 200 is used as an example. A setting instruction (http://192.168.1.1:8080/servers, name, [a-z, 0-9]{4}) indicates that in the access request in which the URL is http://192.168.1.1:8080/servers, a value range of a request parameter name is a-z or 0-9, and a length of name is 4.

In a non-intrusive deployment scenario, the case generation unit performs steps 200 to 206 a plurality of times to obtain a plurality of preceding access requests that carry a same URL and operation code, and then determines the value range of the request parameter and/or the request body in the access request based on values of request parameters and/or request bodies in the plurality of preceding access requests. If the request parameter and/or the request body include/includes digits, the value range is from a minimum value to a maximum value of the digits in the request parameter and/or the request body. If the request parameter and/or the request body include/includes characters, the value range is various permutations and combinations of the characters included in the request parameter and/or the request body.

For example, the plurality of access requests each carry a URL http://192.168.1.1:8080/servers, a length of a request parameter name in each of the plurality of access requests is 4, and values of all characters of name include 0-9, a, b, d, e, and x. Based on the values of name in the plurality of access requests, in an access request that can carry the URL http://192.168.1.1:8080/servers, a value range of name is a combination of any four of 0-9, a, b, d, e, or x.

If the case generation unit obtains only the request parameter in the access request in step 208, the case generation unit determines the value range of the request parameter in the access request based on the values of the request parameters in the plurality of access requests.

If the case generation unit obtains only the request body in the access request in step 208, the case generation unit determines the value range of the request body in the access request based on the values of the request bodies in the plurality of access requests.

If the case generation unit obtains the request parameter and the request body in the access request in step 208, the case generation unit determines the value ranges of the request parameter and the request body in the access request based on the values of the request parameters and the request bodies in the plurality of access requests. Optionally, the values of the request parameters in the plurality of access requests are used to determine the value range of the request parameter in the access request, and the values of the request bodies in the plurality of access requests are used to determine the value range of the request body in the access request.

The foregoing two implementations (intrusive/non-intrusive) may alternatively be combined. For example, the value range that is of the request parameter and that is set in the setting module is X, and the case generation unit determines, based on the plurality of collected access requests, that the value range of the request parameter is Y. The value range of the request parameter may be a union set of X and Y. A manner of obtaining the value range of the request body is similar to that of obtaining the value range of the request parameter.

After step 210, the case generation unit combines and stores the fields in the access request, and the value range of the request parameter and/or the request body. Optionally, the case generation unit may further store the fields in the access response, for example

operation code: GET;
request header: header 1;
URL: http://192.168.1.1:8080/servers;
request parameter: name=test;
request body:
{body: ...
};
value range of the request parameter:

name: range 1;

value range of the request body:

body: range 2;

return code: 200;
response body:
{“name”: “test”,
“flavor”: “large”,
“status”: “running”
}.

The return code and the response body belong to the access response.

212. The case generation unit obtains a preceding access request on which the access request depends. A preceding access request for one access request is sent to the to-be-tested software before the access request. If one access request depends on a preceding access request, the to-be-tested software cannot correctly respond to the access request before the depended-on preceding access request is sent to the to-be-tested software and the to-be-tested software has responded to the depended-on preceding access request.

Some access requests depend on preceding access requests. For example, an access request used to access a virtual machine depends on an access request used to establish the virtual machine. A client can send, based on an identifier (ID) that is of the virtual machine and that is carried in an access response, the access request used to access the created virtual machine, only after a virtual machine management platform receives the access request used to establish the virtual machine, creates the virtual machine, and sends information about the created virtual machine, for example, the ID of the virtual machine, to the client using the access response. The access request used to access the virtual machine carries the ID of the virtual machine. Therefore, the access request used to access the virtual machine depends on the access request used to establish the virtual machine.

In an intrusive deployment scenario, a designer of the to-be-tested software may preset a dependency relationship between access requests in the setting module. The case generation unit obtains, based on the dependency relationship between the access requests in the setting module, a preceding access request on which an access request depends.

In a non-intrusive deployment scenario, if the case generation unit determines that the request parameter or the request body in the access request is carried in a preceding access request or an access response corresponding to the preceding access request, the access request depends on the preceding access request.

The foregoing two implementations (intrusive/non-intrusive) may alternatively be combined. For example, the dependency relationship that is set in the setting module indicates that a preceding access request on which an access request 1 depends is an access request 2, and the case generation unit determines that a preceding access request on which the access request 1 depends is an access request 3. It may be determined that the preceding access request for the access request 1 is the access request 2 and/or the access request 3.

After step 212, the case generation unit combines and stores the preceding access request on which the access request depends, the value range of the request parameter and/or the request body, and the fields in the access request, for example

operation code: GET;
request header: header 1;
URL: http://192.168.1.1:8080/servers;
request parameter: name=test;
request body:
{body: ...
};
value range of the request parameter:

name: range 1;

value range of the request body:

body: range 2;

return code: 200;
response body:
{“name”: “test”,
“flavor”: “large”,
“status”: “running”
};

depended-on access request: POST URL: http://192.168.1.1:8080/servers.

Step 212 is optional. An execution sequence of step 212 is not limited, provided that step 212 is performed before test cases corresponding to the access request are executed.

214. The case generation unit generates, based on the value range of the request parameter and/or the request body in the access request, test cases corresponding to the access request.

After obtaining the value range, the case generation unit generates the plurality of test cases using an operation code, a request header, and a URL that are the same as those in the access request. Request parameters and/or request bodies in the test cases are different. A request parameter in each test case is within the value range of the request parameter. A request body in the test case is within the value range of the request body.

The request parameters and/or the request bodies in the plurality of test cases should cover the value range of the request parameter and/or the request body as much as possible. Preferably, the request parameters and/or the request bodies in the plurality of test cases completely cover the value range of the request parameter and/or the request body. The following uses an example in which the test cases are generated based on the value range of the request parameter, and the same applies to the request body

access request: GET header 1 URL: http://192.168.1.1:8080/servers;

request parameter: name-test;

length of the request parameter: 4;

value range of the request parameter: [a-z, 0-9].

In this case, a request parameter in each generated test case includes any four characters in [a-z, 0-9].

If a naming standard for the request parameter specifies that a same character or digit cannot be repeatedly used, a total of C₃₆4, namely, 58905, test cases can be generated when request parameters in the generated test cases completely cover the value range of the request parameter. If a naming standard for the request parameter specifies that a same character or digit can be repeatedly used, 364 test cases can be generated when request parameters in the generated test cases completely cover the value range of the request parameter. The request parameters in the generated test cases may not completely cover the value range of the request parameter, to avoid a long test time caused by a large quantity of test cases.

216. The case generation unit sends the generated test cases to a case execution unit.

218. The case execution unit executes the generated test cases.

There may be a comparatively large quantity of test cases. Therefore, the case execution unit may include one or more physical servers, and each physical server is responsible for executing some test cases.

Each test case includes one test access request, and that the case execution unit executes the test cases includes sending the test access request to the to-be-tested software. Subsequently, the case execution unit receives a test access response returned by the to-be-tested software based on the test access request. The case execution unit determines, based on a return code in the test access response, whether the test access response is normal. The case execution unit may alternatively compare a response body in the test access response with a response body in the previously recorded access request, and if both the response bodies are the same, determine that the access response is normal.

If one generated access request depends on a preceding access request, before step 216, the case execution unit needs to send the depended-on preceding access request to the to-be-tested software. Otherwise, after receiving the test access request, the to-be-tested software cannot normally respond to the test access request.

The case generation unit may further collect a frequency of invoking access requests carrying a same URL, namely, a quantity of times the to-be-tested software receives, within a same time, the access requests carrying the same URL, and send the frequency of invoking the access requests carrying the same URL to the case execution unit. When performing step 218, the case execution unit may execute, based on frequencies of invoking access requests carrying different URLs, test cases generated based on the access requests carrying different URLs. A test case generated based on an access request that is invoked more frequently is usually executed more frequently. This ensures that the access request that is invoked more frequently and is more important is tested more frequently and is more stable.

For example, an access request 1 carrying a URL 1 is invoked at a frequency of 500 times per hour, and an access request 2 carrying a URL 2 is invoked at a frequency of 2000 times per hour. In this case, the case execution unit more frequently executes a test case generated based on the access request 2, to ensure that a function corresponding to the access request 2 runs normally.

In the foregoing test method, a test case may be automatically generated based on an access request received by the to-be-tested software, and the test case is executed. A tester does not need to write a test case, and test costs are reduced. In addition, value ranges of a request parameter and a request body in the automatically generated test case can better cover various situations, and test coverage is improved.

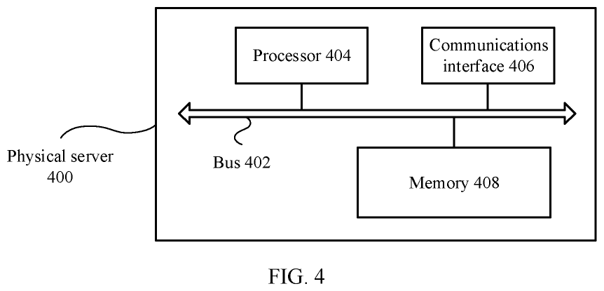

FIG. 4 provides a physical server 400. The physical server 400 may be applied to the foregoing systems. A case generation unit or a part of the case generation unit runs on the physical server 400, or a case execution unit or a part of the case execution unit runs on the physical server 400.

The physical server 400 includes a bus 402, a processor 404, a memory 408, and a communications interface 406. The processor 404, the memory 408, and the communications interface 406 communicate with each other using the bus 402.

The processor 404 may be a central processing unit (CPU). The memory 408 may include a volatile memory, for example, a random-access memory (RAM). The memory 408 may further include a non-volatile memory, for example, a read-only memory (ROM), a flash memory, an HDD, or an SSD. The physical server 400 communicates with to-be-tested software through the communications interface 406.

When the case generation unit runs on the physical server 400, the memory 408 stores a program, and the processor 404 executes the program to perform the actions of the case generation unit in the foregoing method. Specifically, steps 208 to 216 and optional solutions thereof are included.

When a part of the case generation unit runs on the physical server 400, the memory 408 stores a program, and the processor 404 executes the program to perform some of the actions of the case generation unit in the foregoing method. Specifically, one or more steps in steps 208 to 216 and optional solutions thereof are included.

When the case execution unit runs on the physical server 400, the memory 408 stores a program, and the processor 404 executes the program to perform step 218.

When a part of the case execution unit runs on the physical server 400, the memory 408 stores a program, and the processor 404 executes the program to execute some generated test cases.

The physical server 400 may automatically generate a test case based on an access request received by the to-be-tested software, and execute the test case. A tester does not need to write a test case, and test costs are reduced. In addition, value ranges of a request parameter and a request body in the automatically generated test case can better cover various situations, and test coverage is improved.

A service system includes a plurality of physical servers 400, and one or more pieces of to-be-tested software run on each physical server 400. In a non-intrusive deployment scenario, one piece of to-be-tested software and a collection module corresponding to the to-be-tested software usually run on a same physical server 400. The memory 408 of the physical server 400 in the service system stores a program. The processor 404 executes the program to perform the actions of the to-be-tested software, the collection module corresponding to the to-be-tested software, and the setting module corresponding to the to-be-tested software in the foregoing method.

In the foregoing embodiments, descriptions of the embodiments have respective focuses. For a part that is not described in detail in an embodiment, refer to related descriptions in other embodiments.

The method described with reference to the content disclosed in this application may be implemented in a manner of executing a software instruction by a processor. The software instruction may include a corresponding software module. The software module may be stored in a RAM, a flash memory, a ROM, an erasable programmable ROM (EPROM), an electrically erasable programmable ROM (EEPROM), a hard disk, an optical disc, or a storage medium of any other form well-known in the art.

A person skilled in the art should be aware that in the foregoing one or more examples, functions described in this application may be implemented by hardware or software. When being implemented by software, the functions may be stored in a computer-readable medium or transmitted as one or more instructions or code in the computer-readable medium. The storage medium may be any usable medium accessible to a general-purpose or dedicated computer.

The objectives, technical solutions, and beneficial effects of this application are further described in detail in the foregoing specific embodiments. It should be understood that the foregoing descriptions are merely specific embodiments of this application, but are not intended to limit the protection scope of this application. Any modification or improvement made based on the technical solutions of this application shall fall within the protection scope of this application.

1. A test method, comprising:
obtaining an access request from to-be-tested software, wherein the access request comprises an operation code, a Uniform Resource Locator (URL), and a request parameter;
obtaining a first value range of the request parameter;
generating a plurality of test cases corresponding to the access request based on the first value range, wherein each of the test cases comprises the operation code, the URL, and a second request parameter is within the first value range; and
executing the test cases for the to-be-tested software.

2. The test method of claim 1, wherein the access request further comprises a request body, wherein the test method further comprises:
obtaining a second range of the request body; and
further generating the test cases based on the second value range, wherein the request parameter is within the first value range, and wherein a request body in each of the test cases is within the second value range.

3. The test method of claim 1, further comprising:
obtaining a plurality of preceding access requests, wherein each of the preceding access requests comprises the operation code, the URL, and the request parameter; and
determining the first value range based on the request parameter in each of the preceding access requests.

4. The test method claim 1, further comprising determining a preceding access request on which the access request depends, wherein before executing the test cases corresponding to the access request, the test method further comprises sending the preceding access request to the to-be-tested software.

5. The test method of claim 1, further comprising:
obtaining a first frequency of invoking the access request that carries the URL; and
determining a second frequency of executing the test cases corresponding to the access request for the to-be-tested software based on the first frequency.

6. A test system, comprising:
a processor; and
a memory coupled to the processor and storing instructions that, when executed by the processor, cause the test system to be configured to:
obtain an access request from to-be-tested software, wherein the access request comprises an operation code, a Uniform Resource Locator (URL), and a request parameter;
obtain a first value range of the request parameter in the access request;
generate a plurality of test cases corresponding to the access request based on the first value range, wherein each of the test cases comprises the operation code, the URL, and a second request parameter is within the first value range; and
execute the test cases for the to-be-tested software.

7. The test system of claim 6, wherein the instruction further cause the test system to be configured to:
obtain a second value range of a request body in the access request; and
further generate the test cases based on the second value range, wherein the request parameter is within the first value range wherein a request body in each of the test cases is within the second value range.

8. The test system of claim 6, wherein the instructions further cause the test system to be configured to:
obtain a plurality of preceding access requests, wherein each of the preceding access requests comprises the operation code, the URL, and the request parameter; and
determine the first value range based on the request parameter in each of the preceding access requests.

9. The test system of claim 6, wherein the instructions further cause the test system to be configured to determine a preceding access request on which the access request depends, wherein before the instructions that cause the test system to execute the test cases, the instructions further cause the test system to be configured to send the preceding access request to the to-be-tested software.

10. The test system of claim 6, wherein the instruction further cause the test system to be configured to:
obtain a first frequency of invoking the access request that carries the URL; and
determine a second frequency of executing the test case for the to-be-tested software based on the first frequency.

11. A computer program product comprising computer-executable instructions for storage on a non-transitory computer readable medium that, when executed by a processor, cause a physical server to:
obtain an access request to-be-tested software, wherein the access request comprises an operation code, a Uniform Resource Locator (URL), and a request parameter;
obtain a first value range of the request parameter in the access request;
generate a plurality of test cases of the access request based on the first value range, wherein each of the test cases comprises the operation code, the URL, and a second request parameter is within the first value range; and
execute the test cases for the to-be-tested software.

12. The computer program product of claim 11, wherein the access request further comprises a request body, wherein the instructions further cause the physical server to:
obtain a second value range of the request body in the access request; and
further generate the test cases based on the the second value range, wherein the request parameter is within the first value range, and wherein a request body in each of the test cases is within the second value range.

13. The computer program product of claim 11, wherein the instructions further cause the physical server to:
obtain a plurality of preceding access requests, wherein each of the preceding access requests comprises the operation code, the URL, and the request parameter; and
determine the first value range based on the request parameter in each of the preceding access requests.

14. The computer program product of claim 11, wherein the access request further comprises a request body, wherein the instructions further cause the physical server to determine a preceding access request on which the access request depends. wherein before the instructions cause the physical server to execute the test cases, the instructions further cause the physical server to send the preceding access request to the to-be-tested software.

15. The computer program product of claim 11, wherein the instructions further cause the physical server to:
obtain a first frequency of invoking the access request that carries the URL; and
determine a second frequency of executing the test cases for the to-be-tested software based on the first frequency.

16. The computer program product of claim 11, wherein the instructions further cause the physical server to:
receive an access response from the to-be-tested software; and
determine an abnormal return code in response to receiving the access response.

17. The test method of claim 1, further comprising:
receiving an access response from the to-be-tested software; and
determining an abnormal return code in response to receiving the access response.

18. The test method of claim 17, wherein the access response is a Hypertext Transfer Protocol (HTTP) response.

19. The test system of claim 6, wherein the instructions further cause the test system to be configured to:
receive an access response from the to-be-tested software; and
determine an abnormal return code in response to receiving the access response.

20. The test system of claim 19, wherein the access response is a Hypertext Transfer Protocol (HTTP) response.
